(19) United States
(12) Patent Application Publication
(10) Pub. No.: US 2026/0189091 A1
(43) Pub. Date: Jul. 2, 2026

(54) Cooling-Fluid-Guiding Rotor Shaft of an Electric Machine With Impact Wall

(71) Applicant: Bayerische Motoren Werke Aktiengesellschaft, Muenchen (DE)

(72) Inventor: Rafael SABAINI, Wolfern (AT)

(21) Appl. No.: 18/727,562

(22) PCT Filed: Mar. 14, 2023
(86) PCT No.: PCT/EP2023/056464

§ 371 Date: Jul. 9, 2024

(30) Foreign Application Priority Data
Apr. 13, 2022 (DE) 10 2022 109 039.6

(51) Int. Cl. H02K 1/32; H02K 7/00

(52) U.S. Cl. CPC H02K 1/32; H02K 7/003

(57) ABSTRACT

A rotor shaft for a rotor includes a hollow shaft to support a rotor core and to guide a cooling fluid in a cavity formed by a tubular outer wall, an inflow region arranged at the end of the hollow shaft for the cooling fluid to flow into the cavity, which has a pot-shaped housing having a side wall extending around in the circumferential direction and a base wall axially covering the side wall, wherein the base wall and a first part of the side wall are arranged in the cavity, wherein the base wall forms an impact wall to prevent the cooling fluid from axially flowing into the cavity, and wherein the first part of the side wall has at least one radial through opening to provide radial inflow of the fluid into an annular gap in the cavity formed between the side wall and the outer wall.

### BACKGROUND AND SUMMARY

The invention relates to a rotor shaft for a rotor of an electric machine. The rotor shaft has a hollow shaft for supporting a rotor core of the rotor and for conducting a cooling fluid in a cavity, which is formed by way of a tubular outer wall of the hollow shaft, of the hollow shaft. Moreover, the rotor shaft has an inflow region, which is arranged on the end side of the hollow shaft, for the cooling fluid into the cavity. Moreover, the invention relates to a rotor for an electric machine and to an electric machine.

In the present case, interest is directed at electric machines which can be used, for example, as drive machines for electrified motor vehicles, that is to say electric or hybrid vehicles. Electric machines of this type usually have a stator and a rotor which is mounted rotatably with regard to the stator. The rotor has a rotor core, for example a laminated core, through which a rotor shaft is guided and is connected fixedly to the rotor for conjoint rotation. Moreover, the rotor core supports a component of the rotor which generates a magnetic field, for example permanent magnets or energizable rotor windings. In order to cool the rotor, it is known from the prior art for the rotor shaft to be configured as a hollow shaft and to be flowed through with a cooling fluid, for example an oil.

The cooling fluid is usually introduced into the hollow shaft axially on one side of the hollow shaft, for example an output side or transmission side, and leaves the hollow shaft via outlet openings, for example bores on the output side and on a side which lies axially opposite the output side, in order, for example, to distribute it for cooling onto stator winding heads of the stator. An adjustment of the oil quantity between the output side and the opposite rotor side usually does not take place independently of the rotational speed, since the introduced oil quantity has an axial component which is independent of the rotational speed and a radial component which is dependent on the rotational speed.

It is an object of the present invention to provide a simple solution for cooling an electric machine independently of the rotational speed.

According to the invention, this object is achieved by way of a rotor shaft, a rotor and an electric machine with the features according to the present disclosure. Advantageous embodiments of the invention are also the subject matter of the description and the figures.

A rotor shaft according to the invention for a rotor of an electric machine has a hollow shaft for supporting a rotor core of the rotor and for conducting a cooling fluid in a cavity, which is formed by way of a tubular outer wall of the hollow shaft, of the hollow shaft. Moreover, the rotor shaft has an inflow region, which is arranged on the end side of the hollow shaft, for the cooling fluid into the cavity. The inflow region has a pot-shaped housing which has a side wall, which runs around in the circumferential direction, and a bottom wall, which axially covers the side wall. Here, the bottom wall and at least one part of the side wall are arranged in the cavity, the bottom wall configuring a baffle wall for the cooling fluid for preventing an axial inflow of the cooling fluid into the cavity, and that part of the side wall which protrudes into the cavity having at least one radial through opening for providing a radial inflow of the cooling fluid into an annular gap, which is formed between the side wall and the outer wall, in the cavity.

Part of the invention is, moreover, a rotor for an electric machine, comprising a rotor core, a component which generates a magnetic field and is held by the rotor core, and a rotor shaft according to the invention. An electric machine according to the invention for a motor vehicle has a stator and a rotor according to the invention which is mounted rotatably with regard to the stator. The electric machine can be a permanently excited electric machine, in the case of which that component of the rotor which generates a magnetic field has permanent magnets, or it can be a separately excited electric machine, in the case of which that component of the rotor which generates a magnetic field has energizable windings. The rotor core of the rotor can be configured, for example, as a laminated core from axially stacked sheet metal laminates and can have an axial leadthrough for the rotor shaft, to which the rotor core is connected fixedly for conjoint rotation.

The rotor shaft has the hollow-cylindrical hollow shaft which extends in the axial longitudinal direction. The tubular outer wall of the hollow shaft has an outer side which faces the rotor core and an inner side which faces the cavity. The hollow shaft is of open configuration at one of the axial ends, in particular at the transmission-side end, via which the rotor shaft can be coupled for the transmission of torque to a transmission shaft of a transmission of the motor vehicle and at which the inflow region for the cooling fluid into the cavity is situated. The cooling fluid can be oil, for example. The other end which lies axially opposite the transmission-side end can be covered on the end side, for example, and can therefore be closed. The inflow region has the pot-shaped, in particular cylindrical pot-shaped, housing which is arranged at least partially in the cavity. The housing and the hollow shaft are, in particular, configured in one part or are connected to one another such that they cannot be released without destruction, for example are welded or soldered.

The inflow region preferably additionally configures a coupling region for coupling to a transmission or a transmission component of the transmission of the motor vehicle. For example, the coupling region can be configured for coupling to a transmission shaft of the transmission. To this end, an inner side of the side wall of the housing can have a toothing system which configures a spline connection with an external toothing system on the transmission shaft. The coupling region can also have a transmission pinion of the transmission which is configured in one part with the hollow shaft. A part, which projects out of the cavity, of the side wall of the housing of the inflow region can configure, moreover, a radial seat or bearing seat for a bearing of the electric machine.

Here, an external diameter of the housing is smaller than an internal diameter of the hollow shaft, with the result that an annular gap is formed between an outer side of the side wall of the housing and the inner side of the outer wall of the hollow shaft. Here, the annular gap is covered on the end side by way of an annular cover portion which, for example, can be configured in one part with the housing and can be connected to the outer wall of the hollow shaft.

The bottom wall closes off the housing axially here, with the result that the cooling fluid which is introduced into the housing cannot penetrate axially into the cavity, but rather rebounds on the bottom wall. In order to provide an exclusively radial penetration of the cooling fluid into the cavity, the side wall has the at least one through opening, for example four through openings which are arranged distributed in the circumferential direction. The cooling fluid from the housing can thus penetrate via the at least one through opening radially into the annular gap, and can flow in the direction of the outer wall. The cooling fluid can bounce off there, for example, and can therefore be distributed in the direction of the two ends of the hollow shaft which lie axially opposite one another. As a result, the cooling fluid is distributed over an entire axial length of the hollow shaft as far as the two ends of the hollow shaft which lie axially opposite one another. A distribution ratio of the cooling fluid can be set, for example, via an internal geometry of the hollow shaft here.

The hollow shaft preferably has, on end portions of the outer wall which lie axially opposite one another, radial outlet openings for separating the cooling fluid, which exits from the inflow region and flows in the direction of the end portions, into a surrounding region of the rotor. Here, first outlet openings are arranged on a first end portion, for example an outer wall portion which adjoins the transmission-side end, and second outlet openings are arranged on a second end portion, for example an outer wall portion which adjoins the other end. Via the radial outlet openings, the cooling fluid which is distributed axially in the hollow shaft can be separated at two opposite ends, for example on the winding ends of the stator which are situated there and are formed by windings of the stator on axially opposite end sides of a stator core of the stator. Thus, the rotor core can be cooled by way of axial throughflow of the hollow shaft, and the stator can be cooled by way of separation of the cooling fluid.

It can be provided that, in order to set an end portion-specific fluid quantity which exits into the surrounding region, a number and/or a diameter of the first outlet openings are/is different from a number and/or a diameter of the second outlet openings. The outlet openings therefore form static, end portion-specific throttles for regulating the throughflow quantity from the cavity into the surrounding region.

It proves to be advantageous if an inner side of the outer wall has a plurality of cooling fins which run around in the circumferential direction and are spaced apart from one another axially, one cooling fin being arranged so as to overlap in the radial direction with the at least one through opening of the housing, and being designed to adjust a distribution of the cooling fluid, which exits from the inflow region and impacts on the outer wall, in the direction of the end portions which lie axially opposite one another. The inner side of the outer wall is therefore of finned configuration in order to increase the cooling performance, the cooling fins being configured, for example, as respective intermediate walls between two annular grooves which are configured in the inner side. Here, one of the cooling fins is arranged so as to overlap with the at least one through opening of the housing, a distribution ratio of the cooling fluid being dependent on a position of the cooling fin with regard to a center point of the through opening.

The cooling fin which is configured for adjusting the cooling fluid distribution preferably has, with the configuration of a partition for the cooling fluid, a greater radial height than the other cooling fins. As an alternative to this, an outer side of the side wall can have at least one partition element which is arranged at the at least one through opening and is designed to adjust a distribution of the cooling fluid, which exits from the inflow region, in the direction of the end portions which lie axially opposite one another. The at least one partition element has, in particular, a radial portion for distributing the cooling fluid and a deflecting portion which projects axially on both sides from the radial portion for deflecting the cooling fluid in the direction of the axial end portions of the outer wall of the hollow shaft. The partition or the partition element is configured to already carry out the distribution of the cooling fluid at or close to the through opening. The partition or the partition element therefore divides a flow cross section of the through opening into two area portions; the volumetric flows can be set via the area ratio which is provided by way of the positioning of the partition or the partition element.

The embodiments proposed in relation to the rotor shaft according to the invention and their advantages apply mutatis mutandis to the rotor according to the invention and to the electric machine according to the invention.

Further features of the invention result from the claims, the figures and the description of the figures. The features and combinations of features mentioned above in the description and the features and combinations of features mentioned below in the description of the figures and/or shown solely in the figures can be used not only in the respective specified combination, but rather also in different combinations or on their own.

The invention will now be explained in greater detail on the basis of one preferred exemplary embodiment and with reference to the drawings.

### BRIEF DESCRIPTION OF THE DRAWINGS

FIG. 1 shows a perspective illustration of a rotor shaft for a rotor of an electric machine,

FIG. 2 shows a longitudinal sectional illustration of the rotor shaft,

FIG. 3 shows a detail from the longitudinal sectional illustration according to FIG. 2,

FIG. 4 shows the detail according to FIG. 3 in a perspective illustration,

FIG. 5 shows a further detail from the longitudinal sectional illustration according to FIG. 2,

FIG. 6 shows a detail from a longitudinal sectional illustration of a further embodiment of the rotor shaft, and

FIG. 7 shows a detail from a longitudinal sectional illustration of a further embodiment of the rotor shaft.

### DETAILED DESCRIPTION OF THE DRAWINGS

In the figures, identical and functionally identical elements are provided with the same designations.

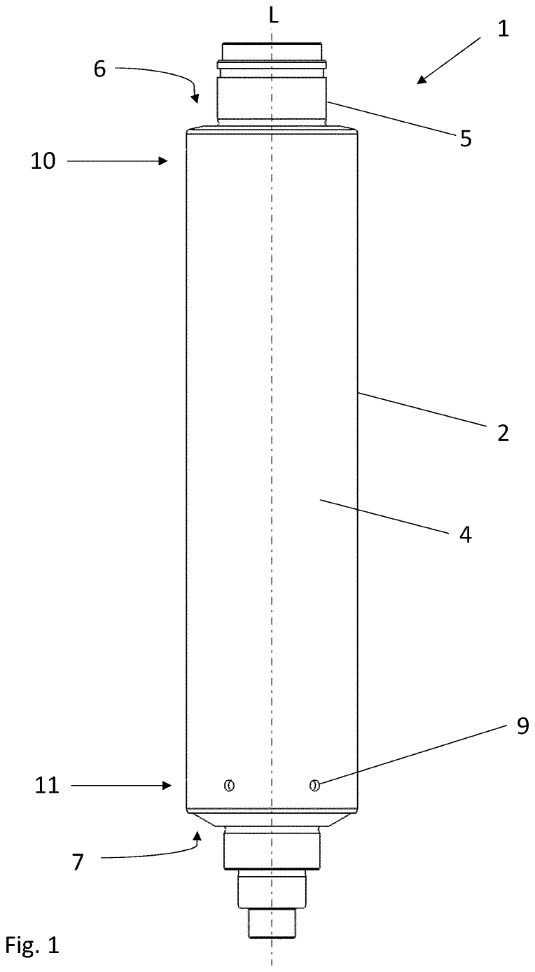

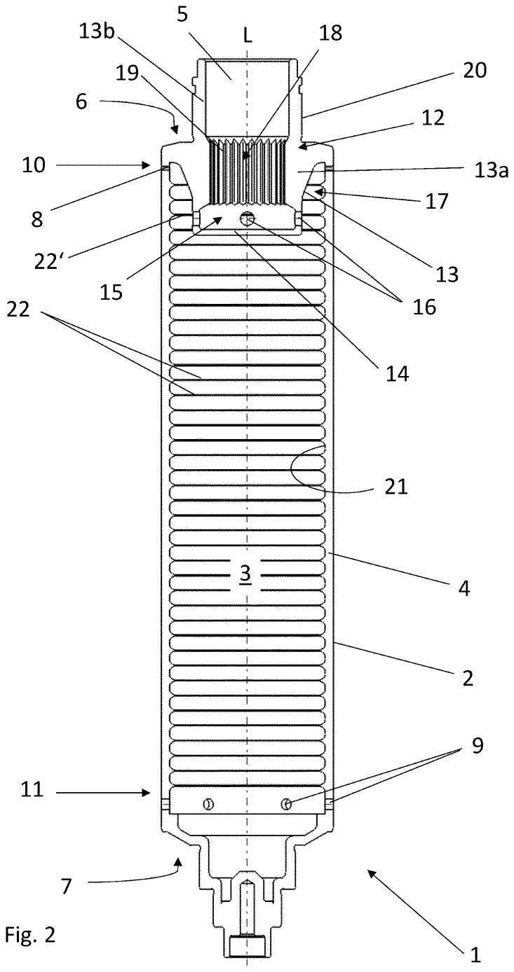

FIG. 1 shows a perspective illustration of a rotor shaft 1 for a rotor of an electric machine of a motor vehicle. An axially extending longitudinal axis L of the rotor shaft 1 corresponds to a rotational axis of the rotor. The rotor shaft 1 has a hollow shaft 2 which, as is shown using the longitudinal section in FIG. 2, is formed by way of an outer wall 4 which encloses a cavity 3. This cavity 3 can be flowed through axially by a cooling fluid which is fed to the hollow shaft 2 via an inflow region 5 of the rotor shaft 1. The inflow region 5 is arranged at a transmission-side end 6 of the hollow shaft 2. An end 7, which lies opposite the transmission-side end 6, of the hollow shaft 2 is of closed configuration.

Here, the cooling fluid which flows through the cavity 3 is separated via outlet openings 8, 9 on two end portions 10, 11 of the outer wall 4 which lie axially opposite one another from the cavity 3 into a surrounding region of the rotor. A number and/or a diameter of first outlet openings 8 on a transmission-side first end portion 10 can differ from a number and/or a diameter of second outlet openings 9 on an opposite second end portion 11. On account of the different numbers and/or diameters of the outlet openings 8, 9, a quantity of the cooling fluid which is separated via the respective outlet openings 8, 9 can be set or adjusted.

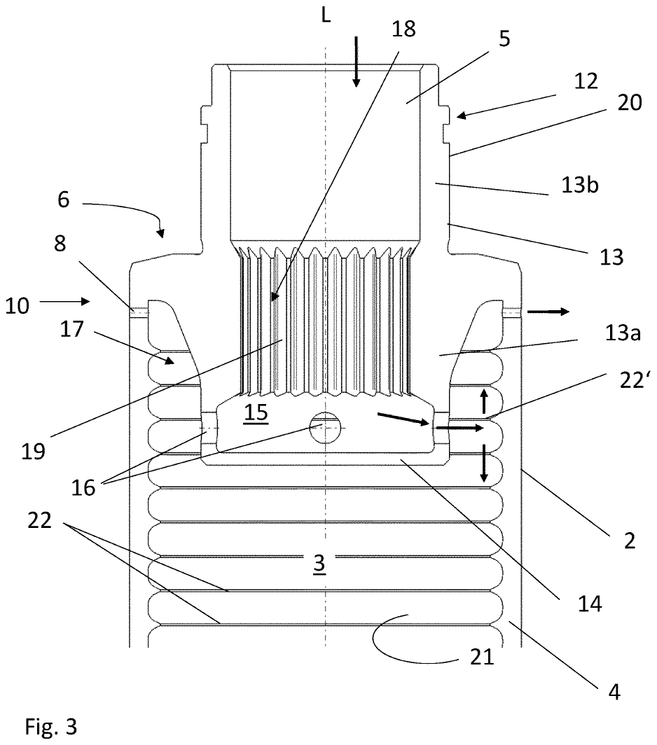

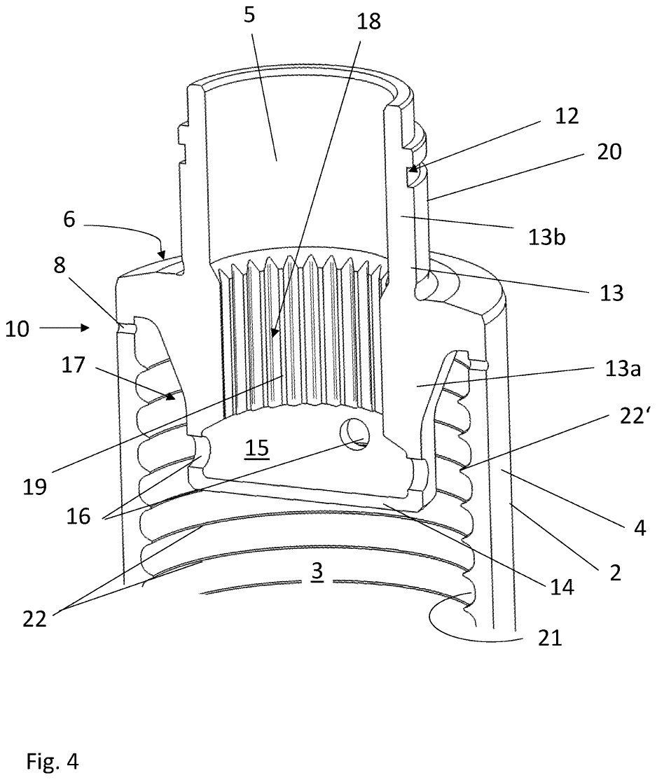

The inflow region 5, of which a detail is shown from different perspectives in FIG. 3 and FIG. 4, is designed here in such a way that the cooling fluid can flow into the cavity 3 only radially. To this end, the inflow region 5 has a pot-shaped housing 12 with a side wall 13 and a bottom wall 14. The bottom wall 14 covers an interior space 15 of the housing 12 axially, with the result that the bottom wall 14 blocks an axial inflow of the cooling fluid and therefore configures a baffle wall, arranged in the cavity 3, for the cooling fluid. Here, the side wall 13 is arranged partially in the cavity 3, a part 13a, which is arranged in the cavity 3, of the side wall 13 having radial through openings 16. Via these through openings 16, the cooling fluid can flow radially, as shown using the arrows in FIG. 3, out of the interior space 15 of the housing 12 into an annular gap 17 which is formed between the part 13a of the side wall 13 and the outer wall 4, can be split from there axially in the direction of the end portions 10, 11, and can flow out of the cavity 3 via the respective outlet openings 8, 9.

Moreover, the inflow region 5 configures a coupling region 18 for a transmission component, for example a transmission shaft, of the transmission and, to this end, has a toothing system 19 here which is configured on an inner side, facing the interior space 15, of the side wall 13. A part 13b, which protrudes out of the cavity 3, of the side wall 13 configures a bearing seat 20 for a bearing of the electric machine. The coupling region 18 can also have a transmission pinion which is integrally formed onto the hollow shaft 2.

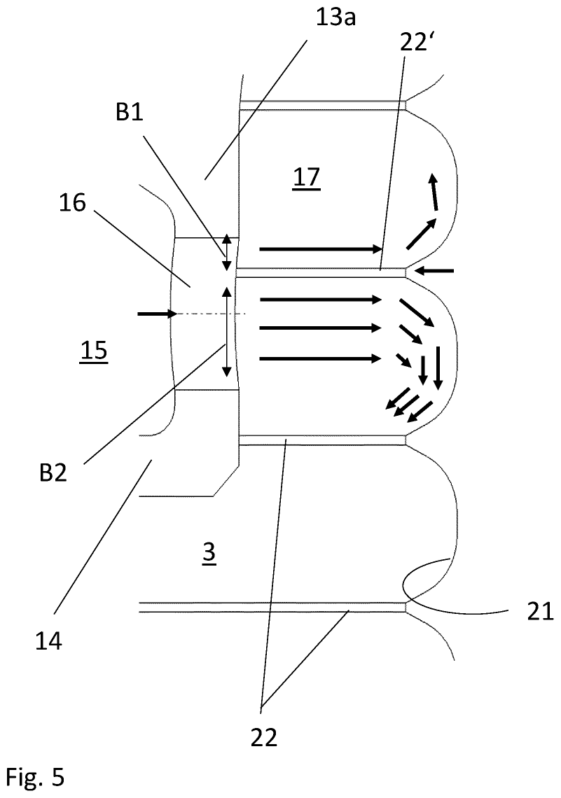

The cooling fluid which enters radially into the annular gap 17 from the housing 12 impinges on an inner side 21 of the outer wall 4 which can be, for example, smooth or can have cooling fins 22, 22′. Here, the cooling fins 22, 22′ are arranged spaced apart axially from one another, protrude radially into the cavity 3, and are configured so as to run around in the circumferential direction. Here, as is shown in a detailed view according to FIG. 5, one of the cooling fins 22′ is arranged so as to be aligned or overlapping with the through openings 16. In other words, the cooling fin 22′ is situated in a radial flow path of the cooling fluid flow, with the result that the cooling fluid impinges onto the cooling fin 22′ and is distributed in the two axial directions. An area ratio B1, B2 of a flow cross section of the through opening 16 which is dependent on a position of the cooling fin 22′ influences the fluid quantity which flows in the respective axial direction.

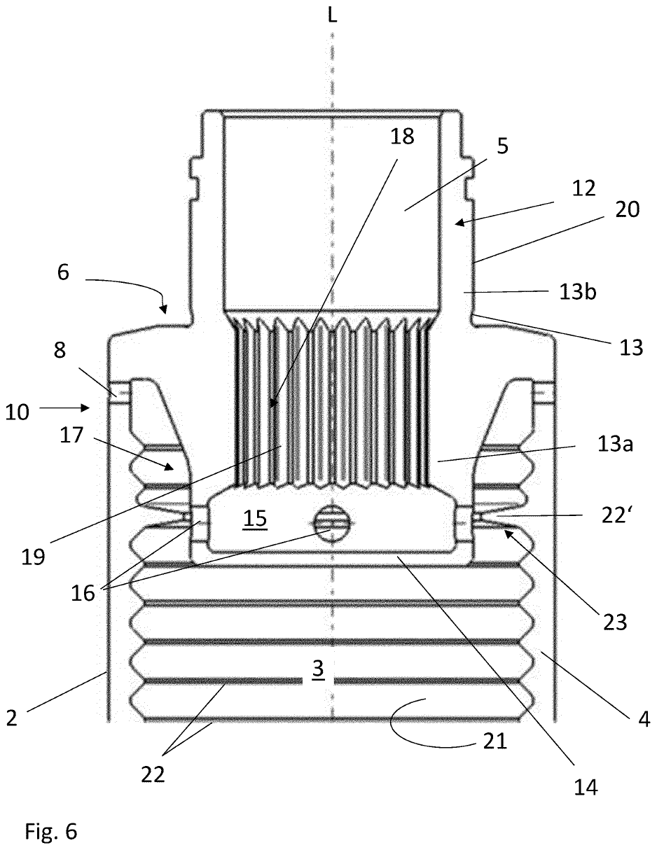

As shown in FIG. 6, this cooling fin 22′ which is provided to distribute the cooling fluid can have a greater radial height than the other cooling fins 22 and, starting from the inner side 21 of the outer wall 4, can protrude as far as the through opening 16. This cooling fin 22′ forms a partition 23 which already distributes the cooling fluid during the exit from the through opening 16. Here, the distributed, substantially radially flowing cooling fluid impinges on both sides of the partition 23 onto the inner side 21 of the outer wall, and is therefore diverted axially to the end portions 10, 11 which lie opposite one another.

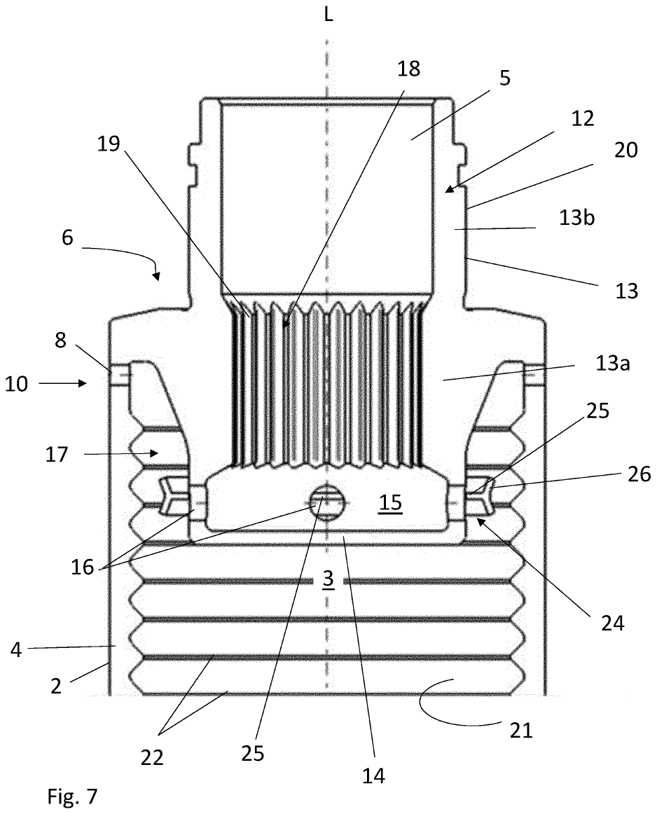

As shown in FIG. 7, a partition element 24 with a T-shaped or Y-shaped cross section can also be arranged on the side wall 13 of the housing 12 so as to overlap with the through opening 16. This partition element 24 has a radial portion 15 for distributing the cooling fluid and an axially projecting deflecting portion 16 for deflecting the radially flowing cooling fluid in the axial direction to the two end portions 10, 11. The partition element 24 can be configured, for example, in one part with the housing 12 or such that it is connected fixedly to the housing 12.

1-12. (canceled)

13. A rotor shaft for a rotor of an electric machine comprising:
a hollow shaft configured to support a rotor core of the rotor and to conduct a cooling fluid in a cavity which is formed by way of a tubular outer wall;
an inflow region arranged on an end side of the hollow shaft and configured to allow inflow of the cooling fluid into the cavity, the inflow region comprising:
a pot-shaped housing having a side wall that runs around in a circumferential direction; and
a bottom wall that axially covers the side wall,
wherein the bottom wall and at least one first part of the side wall are arranged in the cavity, the bottom wall comprising a baffle wall for the cooling fluid to prevent an axial inflow of the cooling fluid into the cavity, and
wherein the at least one first part of the side wall which protrudes into the cavity has at least one radial through opening configured to provide a radial inflow of the cooling fluid into an annular gap that is formed between the side wall and the outer wall in the cavity.

14. The rotor shaft according to claim 13,
wherein the inflow region is arranged at a transmission-side end of the hollow shaft and comprises a coupling region configured to couple to a transmission of a motor vehicle.

15. The rotor shaft according to claim 13,
wherein the
a second part of the side wall of the housing of the inflow region, wherein the second part projects on the hollow shaft and comprises a bearing seat for a bearing of the electric machine.

16. The rotor shaft according to claim 13,
wherein the housing and the hollow shaft are configured in one part or are connected to one another such that they cannot be released without destruction.

17. The rotor shaft according to claim 13,
wherein the hollow shaft comprises, on end portions of the outer wall that lie axially opposite one another, radial outlet openings configured to separate the cooling fluid that exits radially from the inflow region and flows axially in a direction of the end portions, into a surrounding region of the rotor.

18. The rotor shaft according to claim 17,
wherein, in order to set an end portion-specific fluid quantity that exits into the surrounding region, a number and/or a diameter of first outlet openings of a first one of the end portions are/is different from a number and/or a diameter of second outlet openings of a second one of the end portions.

19. The rotor shaft according to claim 17,
wherein an inner side of the outer wall facing the cavity comprises a plurality of cooling fins that run around in the circumferential direction, wherein the plurality of cooling fins are spaced apart axially from one another and protrude radially into the cavity,
wherein at least one cooling fin of the plurality of cooling fins is arranged in a radially aligned manner with respect to the at least one through opening of the housing and is configured to adjust a distribution of the cooling fluid that exits from the inflow region and impacts on the inner side of the outer wall in the direction of the end portions which lie axially opposite one another.

20. The rotor shaft according to claim 19,
wherein the at least one cooling fin which is configured to adjust the distribution of the cooling fluid has, with the configuration of a partition for the cooling fluid, a greater radial height than other cooling fins of the plurality of cooling fins.

21. The rotor shaft according to claim 17,
wherein an outer side, facing the cavity, of the side wall comprises at least one partition element that is arranged at the at least one through opening and is configured to adjust a distribution of the cooling fluid that exits from the inflow region, in the direction of the end portions that lie axially opposite one another.

22. The rotor shaft according to claim 21,
wherein the at least one partition element has a radial portion configured to distribute the cooling fluid and a deflecting portion that projects axially on both sides from the radial portion and is configured to deflect the cooling fluid in the direction of the axial end portions of the outer wall of the hollow shaft.

23. A rotor for an electric machine comprising:
a rotor core;
a component which generates a magnetic field and is held by the rotor core; and
the rotor shaft according to claim 13.

24. An electric machine for a motor vehicle comprising:
a stator; and
the rotor according to claim 23, which is mounted rotatably with regard to the stator.
